(19) United States
(12) Patent Application Publication
(10) Pub. No.: US 2012/0003060 A1
(43) Pub. Date: Jan. 5, 2012

(54) SCREW

(75) Inventor: Sang Hwan Park, Gyunggi-do (KR)

(73) Assignee: SAMSUNG ELECTRO-MECHANICS CO., LTD., Gyunggi-do (KR)

(21) Appl. No.: 13/172,722

(22) Filed: Jun. 29, 2011

(30) Foreign Application Priority Data
Jul. 1, 2010 (KR) 1020100063414

(51) Int. Cl. F16B 39/24

(52) U.S. Cl. 411/360

(57) ABSTRACT

Disclosed herein is a screw, including: a screw head part; a body including screw threads and screw grooves; and a flange part integrally formed with the body, while being spaced from the screw head part, and having a washer shape elastically deformed at the time of being fastened.

### CROSS REFERENCE TO RELATED APPLICATION

This application claims the benefit of Korean Patent Application No. 10-2010-0063414, filed on Jul. 1, 2010, entitled “Screw,” which is hereby incorporated by reference in its entirety into this application.

### BACKGROUND OF THE INVENTION

1. Technical Field

The present invention relates to a screw.

2. Description of the Related Art

A screw (bolt, etc.) is commonly used as an element component for coupling or fixing mechanical apparatuses, components, or the like in designing and assembling thereof; however, it may be loosened due to various external factors.

In particular, in a circuit substrate, a circuit wiring is commonly connected to a chassis (or plate, or the like) using a screw in order to be grounded. However, if the screw is loosened during an operation of a product, it leads to a failure in grounding, such that the product may not normally operate.

In order to prevent such a problem from occurring due to the loosening, a separate component such as a spring washer, or the like, is additionally used or an adhesive is applied in coupling components.

However, the use of a separate component increases costs and causes work inconvenience to degrade workability. In addition, the use of an adhesive or the like has relatively less loosening prevention effects but still increases costs.

### SUMMARY OF THE INVENTION

The present invention has been made in an effort to provide a screw integrally formed with an elastic flange part to prevent the screw from loosening.

A screw according to a preferred embodiment of the present invention includes: a screw head part; a body including screw threads and screw grooves; and a flange part integrally formed with the body, while being spaced from the screw head part, and having a washer shape that elastically deforms at the time of being fastened.

Herein, the flange part may be an elastic member.

The bottom of the screw head part may be formed to be slanted inward and downward.

The flange part may be grounded when a circuit pattern is fastened to a plate in the circuit substrate, while being elastically deformed to the screw head part.

A solder part may be formed between the flange part and the circuit pattern of the circuit substrate.

### BRIEF DESCRIPTION OF THE DRAWINGS

FIG. 1 is a diagram showing a screw according to a preferred embodiment of the present invention, before being fastened;

FIG. 2 is a diagram showing a fastened shape of a screw according to a preferred embodiment of the present invention; and

FIG. 3 is a diagram showing another fastened shape of a screw according to a preferred embodiment of the present invention.

### DESCRIPTION OF THE PREFERRED EMBODIMENTS

Various objects, advantages and features of the invention will become apparent from the following description of the embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, when it is determined that the detailed description of the known art related to the present invention may obscure the gist of the present invention, the detailed description thereof will be omitted.

Hereinafter, a screw according to preferred embodiments of the present invention will be described in detail with reference to the accompanying drawings.

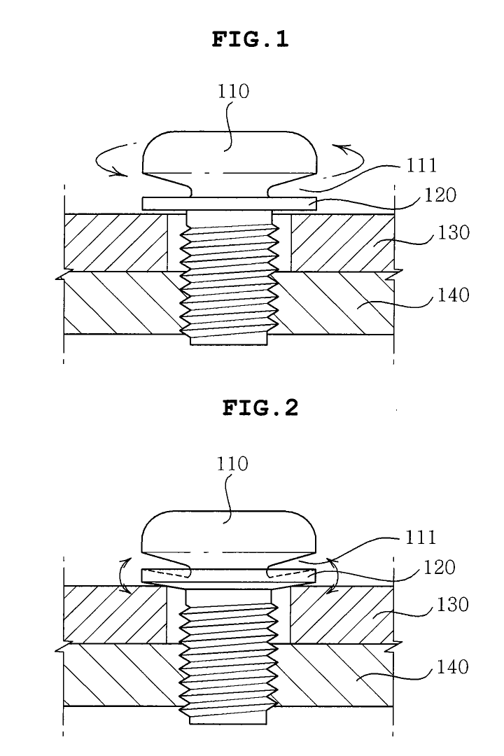

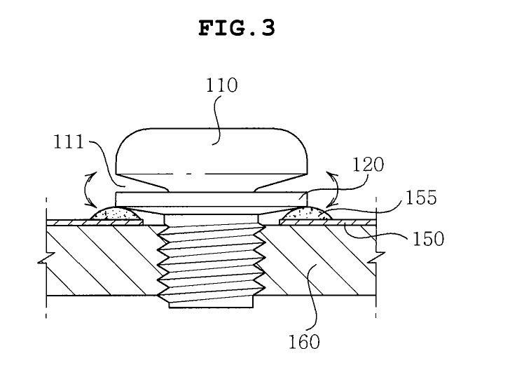

FIG. 1 is a diagram showing a screw according to a preferred embodiment of the present invention, before being fastened, FIG. 2 is a diagram showing a fastened shape of a screw according to a preferred embodiment of the present invention, and FIG. 3 is a diagram showing another fastened shape of a screw according to a preferred embodiment of the present invention.

As shown in FIG. 1, a lower portion of a screw head part 110 according to the present invention is integrally formed with a flange part 120, such that members may be fastened to each other without a separate washer.

A screw body is formed with screw threads and screw grooves, such that a first plate 130 and a second plate 140 may be easily fastened to each other.

A gap 111 is provided between the screw head part 110 and the flange part 120, the gap 111 for securing elastic space of the flange part 120 when engaging members of the screw.

FIG. 2 is a diagram showing a fastened shape between members of a screw according to a preferred embodiment of the present invention. The flange part 120 is formed of an elastic member, which is plastic deformable member, to tighten the screw head part 110, thereby elastically fastening the first plate 130 to the second plate 140.

As the flange part 120 is elastically fastened to the first plate 130, friction force is increased therebetween, thereby making it possible to prevent the screw from loosening.

When the flange part 120 is fastened, the flange part 120 is elastically deformed upwardly, i.e., an opposite direction of the first and second plates 130 and 140, thereby firmly fixing the screw fastened in the first plate 130 and the second plate 140.

In other words, when the fastening of the screw progresses, the flange part 120, which has a structure of preventing loosening, comes in contact with the first plate 130. As the fastening further progresses in order to complete the screw fastening, the outer portion of the flange part 120 is deformed upwardly. At this time, the flange part has elasticity to some extent, which operates the screw in an opposite direction of the fastening, thereby preventing the screw from loosening.

An outer diameter of the flange part 120 corresponds to an outer diameter of the screw head part 110 and the flange part 120 is integrally formed with the screw, such that the screw is fastened to the first and second plates 130 and 140 without requiring a separate washer.

A flange part of a screw according to the prior art generally has no elasticity, such that the screw is frequently loosened when engaging and fixing with a member.

In addition, the flange part with no elasticity is commonly made of a rigid iron material, thereby making it difficult to machine the flange part while incurring expensive production costs.

The gap 111 provided between the screw head part 110 of the screw and the flange part 120 according to the present invention is formed so that the flange part 120 is elastically deformed upwardly easily, which is formed to be slanted inward and downward to the bottom of the screw head part 110.

FIG. 3 is a diagram showing a fastened shape between other members of a screw according to a preferred embodiment of the present invention. FIG. 3 shows a shape in which a screw is fastened to a third plate 160 on which a circuit substrate 150 is mounted.

At this time, the screw fastens the circuit substrate 150 and the third plate 160 and forms a solder part 155 between the flange part 120 and the circuit substrate 150, thereby being grounded.

The solder part 155 allows electricity or signals to flow between members and noise to be reduced.

The screw according to preferred embodiments of the present invention configured as described above is integrally formed with the elastic flange part 120 can prevent the screw from loosening due to increase in friction force without requiring a separate washer at the time of being fastened to members and can sufficiently provide a loosening prevention effect by only fastening a screw, which improves productivity.

In addition, it can prevent a problem that the screw is often loosened when it is assembled with a circuit substrate, a plate or the like to function as a ground.

Although the preferred embodiments of the present invention have been disclosed for illustrative purposes, they are for specifically explaining the present invention and thus a screw according to the present invention is not limited thereto, but those skilled in the art will appreciate that various modifications, additions and substitutions are possible, without departing from the scope and spirit of the invention as disclosed in the accompanying claims.

Accordingly, such modifications, additions and substitutions should also be understood to fall within the scope of the present invention.

What is claimed is:

1. A screw, comprising:
a screw head part;
a body including screw threads and screw grooves; and
a flange part integrally formed with the body, while being spaced from the screw head part, and having a washer shape elastically deformed at the time of being fastened.

2. The screw as set forth in claim 1, wherein the flange part is an elastic member.

3. The screw as set forth in claim 1, wherein the bottom of the screw head part is formed to be slanted inward and downward.

4. The screw as set forth in claim 1, wherein the flange part is grounded when a circuit pattern is fastened to a plate in the circuit substrate, while being elastically deformed to the screw head part.

5. The screw as set forth in claim 4, wherein a solder part is formed between the flange part and the circuit pattern of the circuit substrate.
